(19) United States
(12) Patent Application Publication
(10) Pub. No.: US 2014/0282551 A1
(43) Pub. Date: Sep. 18, 2014

(54) NETWORK VIRTUALIZATION VIA I/O INTERFACE

(71) Applicant: EMULEX DESIGN & MANUFACTURING CORPORATION, Costa Mesa, CA (US)

(72) Inventors: Sujith ARRAMREDDY, Saratoga, CA (US); Chaitanya TUMULURI, Mountain View, CA (US); Jayaram K. BHAT, Cedar Park, TX (US)

(73) Assignee: Emulex Design & Manufacturing Corporation, Costa Mesa, CA (US)

(21) Appl. No.: 13/802,413

(22) Filed: Mar. 13, 2013

(51) Int. Cl. G06F 9/46

(52) U.S. Cl. CPC G06F 9/46
USPC 718/100

(57) ABSTRACT

Network virtualization can be provided via network I/O interfaces, which may be partially or fully aware of the virtualization. Network virtualization can be reflected in the use of a first header and an additional header(s) for a data frame. A partially-aware transmit example can gather together data frame components, including its additional header(s), via a work queue entry. A fully-aware transmit example can refer to a transmit-side table to gather its additional header(s) and can track the state of its additional header(s) stored in a cache. A partially-aware receive example can handle an additional header(s), e.g., by writing it to host-memory. A fully-aware receive example can determine values from multiple headers (including its additional header(s)) to further determine where to write a data payload to host-memory. The examples can relieve a host's hypervisor from performing all the network virtualization processing. The fully-aware examples can incorporate JOY techniques.

### FIELD OF THE DISCLOSURE

This relates generally to network virtualization and, more specifically, to performing network virtualization via network I/O interfaces. The network I/O interfaces may be partially or fully aware of the virtualization of the network.

### BACKGROUND OF THE DISCLOSURE

A computer network system can be described as including three kinds of elements: network hosts, a network interconnecting the hosts, and network input/output (I/O) interfaces that connect the hosts to the network. Hosts may include a computer, a server, a mobile device, or other devices having host functionality. The network may include a router, a switch, transmission medium, and other devices having some network functionality. I/O interfaces may include a network interface controller (NIC) (similarly termed as network interface card or network adapter), such as an Ethernet card, a host bus adapter (as for Fibre Channel), a converged network adapter (CNA) (as for supporting both Ethernet and Fibre Channel), or other devices having network I/O interface functionality. Physical hardware embodiments of these elements can provide a physical instance of the physical resources of a computer network system.

The use of virtualization techniques is a recognized practice in the field of computer networking, such as in the applications of data centers and cloud computing services. When applied to a computer network system, virtualization techniques have been developed to create virtual instances of physical resources in the computer network system. For instance, multiple virtual machines (VMs) can be created to share the same physical resources of a single physical machine, such as a single physical host computer. Each tenant VM residing in a host server-system can be used by a different data center customer. A hypervisor can coordinate the use of the physical resources of the physical machine to create and manage such VMs.

In addition to virtual machines, virtualization techniques have also been developed to create virtual networks. For example, each of two companies may want to use the same physical network resources for its own separate network. Instead of splitting the single physical network into two physically disparate sub-networks, two virtual networks can be created to share the same physical resources of the single physical network. Each of the two companies can have its own separate virtual network.

Although virtualization is a general concept, there can be many permutations of implementations of virtualization techniques in a computer network system, enabled by different technologies. Multiple VMs in a data center can connect to a single physical telecommunication network—virtual machines and physical network—enabled by a hypervisor. Two physical host servers can respectively connect to two different virtual networks—physical machines and virtual networks—enabled by sophisticated routers and switches.

Another permutation under consideration can involve multiple virtual machines in a data center respectively connecting to different virtual networks—virtual machines and virtual networks—enabled by a hypervisor performing all the virtualization. As a hypervisor runs on a physical host processor(s), the physical host processor(s) would provide all the processing necessary to perform this virtualization implementation. The amount of necessary processing can be considerable, such as when managing a high number of VMs. For another example, heavy packet traffic may require heavy I/O processing by the hypervisor.

In addition to virtualizing machines and networks, virtualization techniques have been further developed to create virtual I/O interfaces. For example, a physical host's hypervisor can manage two virtual machines that share a single physical I/O interface, such as a NIC. Two virtual I/O interfaces can be created to share the same physical resources of the single NIC. Each virtual I/O interface can be used by a different virtual machine. Examples of such virtualization of network I/O interfaces are Single Root I/O Virtualization (SR-IOV) (virtual machines in the same physical host computer) and Multi-Root I/O Virtualization (MR-MY) (virtual machines in different physical host computers). One benefit of SR-IOV and MR-IOV is that I/O processing is performed by the physical I/O interface, bypassing the hypervisor. Because the physical host's hypervisor does not perform this I/O processing, the hypervisor can be free to perform other tasks, such as creating more VMs. Also, by bypassing the hypervisor, there can be more direct access between the VMs and the physical I/O interface, which can result in faster and more efficient performance.

As previously mentioned, there can be many permutations of implementations of virtualization techniques in a computer network system. It is not possible, however, to arbitrarily combine all virtualization techniques with each other. For instance, the IOV techniques (SR-IOV and MR-IOV) are mutually exclusive with the implementation of a hypervisor performing the virtualization for virtual machines connecting to virtual networks. This network virtualization requires the hypervisor, but the IOV techniques bypass the hypervisor. Thus, it has not been possible to realize the combined benefits of IOV techniques and virtual machines connecting to virtual networks.

### SUMMARY OF THE DISCLOSURE

Network virtualization can be provided via network I/O interfaces, which may be partially or fully aware of the virtualization of the network. Examples of this disclosure describe transmit and receive techniques for this network virtualization.

A network virtualization transmit device may comprise logic that can provide various transmit functions. The transmit device logic can parse a work queue entry from a host-memory work queue. Based on the parsed work queue entry, the transmit device logic can read a data payload and a first header from a host-memory. The transmit device logic can also read one or more additional headers from one or more additional header locations (e.g., in a host-memory or in a network I/O interface). Based on these read elements (i.e., the data payload, the first headers, the one or more additional headers), the transmit device logic can assemble a data frame.

Network virtualization can be reflected in the use of the multiple headers for the data frame. Of the multiple headers employed by the transmit device logic, the first header can be an inner header, and the one or more additional headers can include an encapsulation header or an outer protocol header.

When reading one or more additional headers from one or more additional header locations, the transmit device logic can do so based on the parsed work queue entry. This aspect may be included in examples of the disclosure that are partially aware of the network virtualization. In this way, transmit device logic of a network I/O interface can gather together data frame components of a data payload, a first header, and even an additional header(s) via a work queue entry.

In some examples of the disclosure, there can be an association between the one or more additional headers and at least one of the work queue entry, the host-memory work queue, and a traffic-flow. Based on this association, the transmit device logic can indicate the one or more additional header locations. Then, the transmit device logic can read the one or more additional headers from the indicated one or more additional header locations. For example, this aspect can be provided in connection with a transmit-side table (and its table entries) of a network I/O interface, which may be fully aware of the network virtualization. In this way, an additional header(s) can be gathered by transmit device logic of a network I/O interface, instead of a hypervisor of the host.

The transmit device logic may also store the one or more additional headers and track the state of the stored one or more additional headers. This aspect can be provided in connection with a cache of a network I/O interface, which may be fully aware of the network virtualization. In this way, transmit device logic of a network I/O device can provide stateful processing, as exemplified by the above tracking of the state of an additional header(s).

A network virtualization receive device may comprise logic that can provide various receive functions. The receive device logic can parse a data frame having a data payload, a first header, and one or more additional headers. The receive device logic can indicate a receive queue in a host-memory. From this receive queue, the receive device logic can parse a receive queue entry to indicate a data buffer in the host-memory. Then, the receive device logic can write the data payload and the first header to this data buffer.

Network virtualization can be reflected in the use of the multiple headers for the data frame. Of the multiple headers employed by the receive device logic, the first header can be an inner header, and the one or more additional headers can include an encapsulation header or an outer protocol header.

The receive device logic can also write the encapsulation header or the outer protocol header to the data buffer. This aspect may be included in examples of the disclosure that are partially aware of the network virtualization. In this way, an additional header(s) can be handled by receive device logic of a network I/O interface.

In some examples of the disclosure, the receive device logic can determine values from two or more of the first header and the one or more additional headers. Then, when indicating the receive queue in the host-memory, the receive device logic can do so based on the determined values. This aspect can be provided in connection with a receive-side table of a network I/O interface, which may be fully aware of the network virtualization. Based on a receive queue entry from the receive queue, the receive device logic of a network I/O interface (not a hypervisor of the host) can determine where to write a data payload to host-memory.

Additionally, the transmit device logic can process the inner header or the encapsulation header and assemble the data frame based on its processed header. The receive device logic can process the inner header or the encapsulation header and write its processed header to the data buffer in the host-memory. In this way, network I/O interfaces can handle other kinds of headers besides outer protocol headers.

The transmit device logic or the receive device logic may be incorporated in a network adapter (e.g., a NIC, an Ethernet card, a host bus adapter (HBA), a CNA). The transmit device logic or the receive device logic may be incorporated in a server or in a network.

The examples of this disclosure can relieve a hypervisor in a host from performing all the processing needed for network virtualization. The fully-aware examples can also incorporate IOV techniques.

### BRIEF DESCRIPTION OF THE DRAWINGS

FIG. 1 illustrates an exemplary network 100 in which some of the examples of this disclosure may be practiced.

FIG. 2 illustrates elements of a partially-aware network I/O interface to transmit data frames to a network.

FIG. 3 illustrates elements of a partially-aware network I/O interface to receive data frames from a network.

FIG. 4 illustrates elements of a fully-aware network I/O interface to transmit data frames to a network.

FIG. 5 illustrates elements of a fully-aware network I/O interface to receive data frames from a network.

FIG. 6 illustrates an exemplary networking system that can be used with one or more examples of this disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Virtualization techniques are being developed wherein physical hosts perform the processing that provides the virtualization. Other virtualization techniques are being developed wherein physical networks perform the processing that provides the virtualization. Physical I/O interfaces sit at the nexus between physical hosts and physical networks.

A processing bottleneck may form at this nexus. For example, virtualization techniques implemented in a physical host may optimize the utilization efficiency of physical processing resources of the physical host, and virtualization techniques implemented in a physical network may optimize the utilization efficiency of physical processing resources of the physical network. A physical I/O interface connecting the physical host to the physical network sits at the nexus. If the physical I/O interface is not virtualized, the utilization efficiency of physical processing resources of the physical I/O interface may not be optimized, which may lead to a bottleneck of processing at the physical I/O interface. For instance, the physical host and the physical network may be able to process high transmission rates of packet traffic due to efficiencies gained by virtualization, but the physical I/O interface may be unable to match the high transmission rates if its efficiency is not sufficiently high.

There have been prior techniques to virtualize a physical I/O interface, such as SR-IOV and MR-IOV. Such prior IOV techniques, however, cannot be combined with all virtualization techniques. For instance, the IOV techniques (SR-IOV and MR-IOV) bypass the hypervisor, thereby excluding a combination with the virtualization technique of a hypervisor performing the virtualization for virtual machines connecting to virtual networks. Thus, even if an IOV technique is utilized at the nexus, another virtualization may be lost—the virtualization for virtual machines connecting to virtual networks.

The examples of this disclosure can mitigate or avoid the processing bottleneck discussed above. The physical I/O interface can perform some processing for network virtualization, e.g., the virtualization for virtual machines connecting to virtual networks. This network virtualization can involve the encapsulation of a data packet from a transmit virtual machine with a set of virtualized network information to form a frame for transport across a virtual network to a receive virtual machine for the decapsulation of the data packet. The frame may comprise the original data packet (e.g., having an inner header(s) and a data payload) and the information about the network virtualization (e.g., having an outer protocol header(s) and an encapsulation header(s)). Some examples of this disclosure may be partially aware of this frame encapsulation/decapsulation. Other examples of this disclosure may be fully aware of this frame encapsulation/decapsulation. Exemplary differences between the partially-aware examples and the fully-aware examples are provided in later discussions below.

FIG. 1 illustrates an exemplary network 100 in which some of the examples of this disclosure may be practiced. The network 100 can include various intermediate nodes 102. These intermediate nodes 102 can be switches, hubs, or other devices. The network 100 can also include various endpoint nodes 104. These endpoint nodes 104 can be computers, mobile devices, servers, storage devices, or other devices. The intermediate nodes 102 can be connected to other intermediate nodes and endpoint nodes 104 by way of various network connections 106. These network connections 106 can be, for example, Ethernet-based, Fibre Channel-based, or can be based on any other type of communication protocol. Network connections 106 can be wired, wireless, or any other communication medium. The endpoint nodes 104 in the network 100 can transmit data to each other through network connections 106 and intermediate nodes 102.

An intermediate node 102 can include a physical network I/O interface 108 that connects one or more physical hosts 110 to a network connection 106. Although the examples of this disclosure focus on physical host(s) 110 and a physical network I/O interface 108 in an endpoint node 104 in a network 100, the scope of this disclosure also extends to physical hosts and physical network I/O interfaces in the middle of a network, such as at an intermediate node 102.

In addition, the scope of this disclosure also includes virtual hosts—VMs within physical hosts 110. These virtual hosts may access the network 100 via a virtual I/O interface maintained by a physical network I/O interface 108. The virtual I/O interface may be exemplified by SR-IOV or MR-IOV mechanisms.

Data can be transmitted through network 100 via a collection of frames constituting an identifiable “flow.” Examples of a “flow” include all frames associated with a physical port or all frames associated with a host Peripheral Component Interconnect Express (PCIe) function or all frames associated with a specific set of queue abstractions exported by an I/O interface 108 (e.g., a CNA) to allow a host 110 to request transmission and reception of frames or even all frames associated with specific values in the frame header. These are representative examples and do not constitute an exhaustive list to define a “flow.”

FIGS. 2 and 3 illustrate examples that are partially aware of frame encapsulation/decapsulation for network virtualization. The representation in FIG. 2 illustrates elements of a partially-aware network I/O interface 208 (e.g., a CNA) to transmit data frames 212 (e.g., Ethernet frames) to a network. The representation in FIG. 3 illustrates elements of a partially-aware network I/O interface 308 (e.g., a CNA) to receive data frames 312 (e.g., Ethernet frames) from a network.

On the transmit side shown in FIG. 2, the host-memory 214 (labeled as “HOST RAM”) depicted in FIG. 2 can be a source for Ethernet frames to be transmitted by CNA 208. Host-memory 214 can represent a pool of memory provided by one or more physical memory devices. Host-memory 214 can be apportioned into distinct memory areas, each memory area associated with a tenant VM 230 or a hypervisor 220 in a host server-system. Hypervisor 220 can create and manage transmission VM (Tx VM) 230.

Host-memory 214 can contain a Work Queue (WQ) 218 belonging to hypervisor 220. WQ 218 can contain one or more Work Queue Entries 222 (WQEs) that specify an Ethernet frame to be transmitted. The owner of WQ 218 (e.g., hypervisor 220) can populate WQ 218 by writing WQEs to WQ 218.

Note that this is an example of a realization and other variants are possible, as well. For example, WQ 218 may be resident in on-board memory in CNA 208, and the owner of WQ 218 (i.e., hypervisor 220 or Tx VM 230) can write WQEs across a bus 224 (e.g., a PCIe Fabric as a shared communication medium) to pre-designated CNA memory location(s) representing WQ 218.

CNA 208 can include one or more DMA engines 240, one or more WQE parsers 226, and one or more offload engines 228. CNA 208 can serve as I/O interface 108 in between physical host(s) 110 and a network connection 106 in FIG. 1. CNA 208 can receive information from host-memory 214 of physical host(s) 110. Based on the received information, CNA 208 can transmit Ethernet frame 212 onto a network connection 106.

Exemplary transmission processes follow. A user of Tx VM 230 would like to transmit data to a reception VM (Rx VM). Both Tx VM 230 and the Rx VM may belong to the same shared virtual network and can communicate with each other by the transmission of frames. Components for a transmission frame destined for the Rx VM are generated: frame payload 232 and inner header(s) (IH) 234. Frame payload 232 can include the data intended for transmission from Tx VM 230 to the Rx VM. IH 234 can have addressing information indicating the specific virtual location of the Rx VM within the shared virtual network.

Hypervisor 220 has or is able to determine information about Tx VM 230 and the Rx VM. Hypervisor 220 can have or access virtual network indicating information (e.g., a virtual network identifier) that indicates the shared virtual network of Tx VM 230 and the Rx VM. The virtual location of the Rx VM resides at a physical space location (e.g., a physical host) that is accessible by a physical access point (e.g., a CNA). Hypervisor 220 can have or access the physical network address of the physical access point (e.g., an Ethernet address of a CNA). Based on the virtual network indicating information or other relevant information and means to obtain such kinds of information (e.g., the EH 236 may be a fixed a-priori piece of information provided by an administrator to the Hypervisor 220), hypervisor 220 can generate encapsulation header (EH) 236. Based on the physical network address of the physical access point, hypervisor can generate outer protocol header(s) (OPH) 238. Hypervisor 220 can generate a set of EH 236 and OPH 238 for every transmission frame.

Inner header(s) 234 and outer protocol header(s) 238 may be headers of Layer 2 (e.g., Ethernet), Layer 3 (e.g., IPv4, IPv6, IPX, etc.), Layer 4 (e.g., TCP, UDP, etc.) and other such protocols as understood by the standard Open Systems Interconnection model (OSI) or similar models.

Hypervisor 220 can create WQEs, such as WQE 222, on a frame-by-frame basis. Hypervisor 220 can populate WQ 218 with WQE 222. WQE 222 can indicate locations of four kinds of frame components: frame payload 232, IH 234, EH 236, and OPH 238. For every transmission frame, the corresponding WQE can indicate the same four kinds of frame components on a per-frame basis.

CNA 208 can obtain WQE 222 from WQ 218. For example, a DMA engine can DMA-fetch or read WQE 222. WQE parser 226 can parse WQE 222 to process the contents of WQE 222. Based on WQE 222, CNA 208 can obtain the frame components of frame payload 232, IH 234, EH 236, and OPH 238 by, e.g., one or more DMA engines 240 DMA-fetching or reading the frame components from host-memory 214.

WQE 222 can also indicate request(s) for offload processing. Such offload processing may be performed by offload engines 228. Prior to transmission of the final Ethernet frame 212, offload engines 228 may perform any requested offload and other processing operations to update and/or transform obtained frame components (e.g., frame payload 232, IH 234, EH 236, OPH 238). Offload engines 228 may perform these processing operations on the frame components separately and then assemble the processed components into a final Ethernet frame 212. Offload engines 228 may assemble the obtained frame components into a preliminary frame and then perform these processing operations on the assembled preliminary frame to produce a final Ethernet frame 212.

Examples of the processing operations performed by offload engines 228 can be varied. These operations could include updates to the L2, L3, L4 destination address elements (e.g., IPv4 address, TCP Port numbers, Ethernet addresses, etc.) in the headers of IH 234 or OPH 238. These operations also could include Layer 3 and Layer 4 Checksum computations, Large Segmentation Offloads, VLAN-Tag insertions, ACL checks, and similar offload processing operations. These operations may be requested and performed on the contents of one or more of IH 234, EH 236, and OPH 238. Additionally, these operations may alter frame payload 232, e.g., by the insertion of padding-bytes. The forwarding process decides the final destination of Ethernet frame 212 as well any differentiated servicing required on Ethernet frame 212. The final destination of Ethernet frame 212 may be the physical Ethernet port or Ethernet frame 212 may be looped back to the host-memory or Ethernet frame 212 may be “dropped” (based on various criteria such as frame header contents and rules in the CNA, etc.) among other options. The differentiated servicing may delay or expedite the forwarding of Ethernet frame 212, e.g., with respect to other in-flight Ethernet frames in the CNA (based on various criteria such a priority, bandwidth constraints, etc.).

CNA 208 may transmit Ethernet frame 212 onto a network connection 106 in FIG. 1. The physical network resources of network 100 may direct Ethernet frame 212 through network 100 based on OPH 238, which may indicate the physical network address of the physical access point to the Rx VM. For example, OPH 238 may indicate the Ethernet address of a CNA servicing the physical host where the Rx VM resides. Eventually, frame payload 232 (including the data intended for transmission from Tx VM 230 to the Rx VM) may be directed to the Rx VM according to various reception techniques, such as provided in, but not limited to, this disclosure.

In an alternative case, both Tx VM 230 and Rx VM may reside in the same physical host. Thus, CNA 208 may route Ethernet frame 212, not onto network connection 106, but within the same physical host. For example, OPH 238 may indicate the Ethernet address of the same CNA 208. Eventually, frame payload 232 (including the data intended for transmission from Tx VM 230 to the Rx VM) may be directed to the Rx VM according to various reception techniques, such as provided in, but not limited to, this disclosure.

The host-memory 314 (labeled as “HOST RAM”) depicted in FIG. 3 can be a sink for Ethernet frames to be received by CNA 308. Host-memory 314 can represent a pool of memory provided by one or more physical memory devices. Hypervisor 320 can create and manage reception VM (Rx VM) 330.

Host-memory 314 can contain a Receive Queue (RQ) 342 belonging to hypervisor 320. RQ 342 can contain one or more Receive Queue Entries (RQEs) that specify the address of buffers where contents of received frames are be deposited. The owner of RQ 342 (e.g., hypervisor 320) can populate RQ 342 by writing RQEs to RQ 342.

Note that this is an example of a realization and other variants are possible, as well. For example, RQ 342 may be resident in on-board memory in CNA 308, and the owner of RQ 342 can write RQEs across a bus 324 (e.g., a PCIe Fabric as a shared bus) to pre-designated CNA memory location(s) representing RQ 342.

CNA 308 can include one or more DMA engines 346, one or more RQE parsers 348, one or more offload engines 350, one or more frame parsers 352, and one or more look-up tables 354. CNA 308 can serve as I/O interface 108 in between physical host(s) 110 and network connection 106 in FIG. 1. CNA 308 can receive Ethernet frame 312 from a network connection 106. Based on the received Ethernet frame 312, CNA 308 can deliver information to host-memory 314 of physical host(s) 110.

Exemplary reception processes follow. A user of a transmission VM (Tx VM) would like to transmit data to Rx VM 330. Both the Tx VM and Rx VM 330 may belong to the same shared virtual network and can communicate with each other by transmission frames. Ethernet frame 312 may be transmitted into network 100 in FIG. 1 according to various transmission techniques, such as provided in, but not limited to, this disclosure. In the case that both the Tx VM and Rx VM 330 reside in the same physical host, CNA 308 may route Ethernet frame 312 directly between Tx VM and Rx VM 330, not through network 100. Ethernet frame 312 in FIG. 3 may correspond to Ethernet frame 212 in FIG. 2 or Ethernet frame 412 in FIG. 4. CNA 308 can receive an Ethernet frame 312 from a network connection 106 in FIG. 1. When both the Tx VM and Rx VM 330 reside in the same physical host, CNA 308 can route Ethernet frame 312 within itself, instead of receiving Ethernet frame 312 from network connection 106. The received Ethernet frame may include the following components: frame payload 332, inner header(s) (IH) 334, encapsulation header (EH) 336, and outer protocol header(s) (OPH) 338.

Frame payload 232 can include the data from Tx VM intended for reception by Rx VM 330. IH 334 can have addressing information indicating the virtual location of Rx VM 330 on the shared virtual network. EH 336 can include virtual network indicating information that indicates the shared virtual network of Tx VM and Rx VM 330. The virtual location of Rx VM 330 resides at a physical space location (e.g., a physical host) that is accessible by a physical access point (e.g., CNA 308). OPH 338 can indicate the physical network address of the physical access point (e.g., an Ethernet address of CNA 308).

Inner header(s) 334 and outer protocol header(s) 338 may be headers of Layer 2 (e.g., Ethernet), Layer 3 (e.g., IPv4, IPv6, IPX, etc.), Layer 4 (e.g., TCP, UDP, etc.) and other such protocols as understood by the standard Open Systems Interconnection model (OSI) or similar models.

Frame parser 352 can parse Ethernet frame 312 to process the contents of Ethernet frame 312. Based on OPH 338, CNA 308 can determine whether Ethernet frame 312 is addressed to CNA 308. If so, CNA 308 can continue processing of Ethernet frame 312. If not, CNA 308 can discard Ethernet frame 312.

Lookup table 354 may include information about a location(s) in host-memory 314 where CNA 308 can write contents of Ethernet frame 312. Lookup table entry 356 may indicate RQ 342 based on one of a number of various bases. For an exemplary basis, some lookup table entries (e.g., 356) may be associated with a certain kind of RQ (e.g., 342) that is designated for a certain kind of received Ethernet frame—e.g., received Ethernet frames directed to virtual machines connecting to virtual networks.

Frame parser 352 can determine that a received Ethernet frame belongs to this kind of Ethernet frame—i.e., an Ethernet frame directed to virtual machines connecting to virtual networks. For example, frame parser 352 can make a determination that Ethernet frame 312 has multiple sets of headers. Based on such a determination, lookup table 354 can provide lookup table entry 356 that indicates RQ 342.

Directed to RQ 342 by lookup table entry 356, CNA 308 can obtain RQE 344 from RQ 342, e.g., by one or more DMA engines 346 DMA-fetching or reading RQE 344 from host-memory 314. RQE parser 348 can parse RQE 344 to obtain the physical address of buffers, e.g., data buffer 358, in host-memory 314 where contents of Ethernet frame 312 may be written.

Prior to forwarding contents of received Ethernet frame 312 to data buffer 358 in host-memory 314, offload engines 350 may perform any requested offload and other processing operations to update and/or transform frame components of Ethernet frame 312 (e.g., frame payload 332, IH 334, EH 336, OPH 338). Examples of the processing operations performed by offload engines 350 can be varied. These operations could include Layer 3 and Layer 4 Checksum computations, Large Segmentation Offloads, VLAN-Tag removals, ACL checks, and similar offload processing operations. These operations may be requested and performed on the contents of one or more of IH 334, EH 336, and OPH 338. Additionally, these operations may alter frame payload 332, e.g., by the removal of padding-bytes.

One or more DMA engines 346 may transfer frame payload 332, IH 334, and EH 336 (and also OPH 338) to data buffer 358. The transferred contents may be updated and/or transformed (or not) by offload engines 350. Hypervisor 320 further processes the transferred contents to eventually direct frame payload 332 (including the data from Tx VM intended for reception by Rx VM 330) to Rx VM 330. For example, based on EH 336, hypervisor 320 may determine virtual network indicating information that indicates the shared virtual network of the Tx VM and Rx VM 330, and, based on IH 334, hypervisor 320 may determine addressing information indicating the virtual location of Rx VM 330 on the shared virtual network. Thus, based on the virtual network indicating information and this addressing information, hypervisor 320 may direct frame payload 332 to Rx VM 330.

The partially-aware examples above can perform stateless offloads processing. One example may be checksum computations on inner headers and encapsulation headers and frame payloads.

FIGS. 4 and 5 illustrate examples that are fully aware of frame encapsulation/decapsulation for network virtualization. The representation in FIG. 4 illustrates elements of a fully-aware network I/O interface 408 (e.g., a converged network adapter (CNA)) to transmit data frames 412 (e.g., Ethernet frames) to a network. The representation in FIG. 5 illustrates elements of a fully-aware network I/O interface 508 (e.g., a converged network adapter (CNA)) to receive data frames 512 (e.g., Ethernet frames) from a network.

On the transmit side shown in FIG. 4, the host-memory 414 (labeled as “HOST RAM”) depicted in FIG. 4 can be a source for Ethernet frames to be transmitted by CNA 408. Host-memory 414 can represent a pool of memory provided by one or more physical memory devices. Host-memory 414 can be apportioned into distinct memory areas 416, each memory area associated with a tenant VM 430 or a hypervisor 420 in a host server-system. Hypervisor 420 can create and manage transmission VM (Tx VM) 430. A single physical CNA 408 could be shared across multiple VMs managed by a single hypervisor 420 (e.g., in the case of an SR-IOV system) or be shared across multiple such server-systems via a shared fabric or bus 424 (e.g., in the case of an MR-IOV system).

Memory area 416 can contain a Work Queue (WQ) 418 belonging to hypervisor 420 or Tx VM 430. WQ 418 can contain one or more Work Queue Entries 422 (WQEs) that specify an Ethernet frame to be transmitted. The owner of WQ 418 (e.g., hypervisor 420 or Tx VM 430) can populate WQ 418 by writing WQEs to WQ 418.

Note that this is an example of a realization and other variants are possible, as well. For example, WQ 418 may be resident in on-board memory in CNA 408, and the owner of WQ 418 (i.e., hypervisor 420 or Tx VM 430) can write WQEs across a bus 424 (e.g., a PCIe Fabric as a shared communication medium) to pre-designated CNA memory location(s) representing WQ 418.

Differences between the partially-aware example of FIG. 2 and the fully-aware example of FIG. 4 exist, e.g., with regard to the respective ways that outer protocol headers and encapsulation headers are handled. In the fully-aware example, hypervisor 420 may populate a pre-designated “Outer Header Region” (OHR) area 460 of host-memory 414 with sets of outer protocol header(s) (OPH) 438 and encapsulation headers (EH) 436. Each set of headers (e.g., a set of EH 436 and OPH 438 together) may be associated with a specific tenant VM 430 for encapsulating its traffic, associated with hypervisor 420 for encapsulating its traffic, or associated even with a specific “flow” of VM 430.

Information describing or indicating these associations may be stored by CNA 408 in OHR Table 462 for use with the encapsulation shown in FIG. 4. These associations may be designated as persistent, designated as volatile requiring explicit destruction mechanisms (e.g., via a command from the host), or designated as volatile requiring implicit destruction mechanisms (e.g., at function reset events). OHR Table 462 in the fully-aware example of FIG. 4 represents an exemplary difference from the partially-aware example of FIG. 2.

Before storage in CNA 408, this information describing or indicating these associations may have been generated or acquired by the host, e.g., by hypervisor 420. This information may have been passed to CNA 408 at the time of tenant VM initialization (e.g., during virtual function (VF) set-up activity) performed by hypervisor 420. Hypervisor 420 may be provided with constructs and instructions that enable it to pre-specify frame-encapsulation policies and parameters for specific traffic-flows (where the flows may be identified based on values in frame headers (i.e., IH 234, EH 236, OPH 238), or based on an association with a specific CNA WQ, or based on an association with specific PCIe functions or flows associated with CNA ports as a whole).

While OHR 460 is shown in host-memory 414 under the control of hypervisor 420 for illustrative purposes, OHR 460 may be completely or partially offloaded to CNA 408 in another realization. Such a realization can include the use of various standard and proprietary methodologies (e.g., networking protocols such as ARP, DNS or vendor-specific protocols and mechanisms) in CNA 408 to obtain the information describing or indicating the associations to populate OHR 460 on-chip. Among other teachings of this disclosure, offloading (complete or partial) of OHR information is not conventionally known.

Exemplary transmission processes follow. A user of Tx VM 430 would like to transmit data to a reception VM (Rx VM). Both Tx VM 430 and the Rx VM may belong to the same shared virtual network and can communicate with each other by transmission frames. Components for a transmission frame destined for the Rx VM are generated: frame payload 432 and inner header(s) (IH) 434. Frame payload 432 can include the data intended for transmission from Tx VM 430 to the Rx VM. IH 434 can have addressing information indicating the virtual location of the Rx VM on the shared virtual network.

Hypervisor 420 or Tx VM 430 can create WQEs, such as WQE 422, on a frame-by-frame basis. Hypervisor 420 or Tx VM 430 can populate WQ 418 with WQE 422. WQE 422 can indicate locations of two kinds of frame components: frame payload 432 and IH 434. For every transmission frame, the corresponding WQE can indicate the same two kinds of frame components on a per-frame basis. WQE 422 may lack any information regarding EH 436 and OPH 438. In contrast, WQE 222 in the partially-aware example of FIG. 2 can indicate four, not two, kinds of frame components: frame payload 232, IH 234, EH 236, and OPH 238.

CNA 408 can obtain WQE 422 from WQ 418. For example, a DMA engine can DMA-fetch or read WQE 422. Enhanced WQE parser 426 can parse WQE 422 to process the contents of WQE 422. Based on WQE 422, CNA 408 can obtain the frame components of frame payload 432 and IH 434 by, e.g., one or more DMA engines 440 DMA-fetching or reading the frame components from host-memory 414.

Lookup OHR Table 462 may include information about a location(s) in OHR 460 in host-memory 414 (or in on-board memory in CNA 408) where CNA 408 can access the proper set of EH 436 and OPH 438 associated with the obtained frame components of WQE 422 (i.e., frame payload 432 and IH 434). OHR Table 462 in on-chip memory of CNA 408 can store the associations of the OHR entry sets with their corresponding tenant VMs. There may be variants to the exact format of the entries—e.g., the association may be made with all the WQs of tenant VM 430 or each WQ of tenant VM 430 may be assigned a different OHR entry set of headers as illustrated in FIG. 4 (i.e., a particular WQ “QP-ID” 464 of Tx VM 430 may be assigned to table entry “OHR-Entry” 466 of OHR Table 462). Entries in OHR Table 462 may be inserted, maintained, updated, or deleted autonomously by CNA 408 (e.g., not by hypervisor 420). Such entries of OHR Table 462 in the fully-aware example of FIG. 4 also represent an exemplary difference from the partially-aware example of FIG. 2.

In addition to storing these associations, OHR Table 462 may provide hints on whether an OHR entry 466 (i.e., a particular set of EH 436 and OPH 438) is in-use and currently available on-chip (i.e., is “cached”) or needs to be fetched or read from OHR 460. Also, the table entries of OHR Table 462 may directly point to a memory location in OHR 460 or may use indirection tables (resident either on-chip in CNA 408 or in host-memory 414) that lead to the memory location in OHR 460. Such indirection tables can minimize address format sizes and increase the addressable area of OHR 460, as well.

CNA 408 has or is able to determine information about Tx VM 430 and the Rx VM, as exemplified by OHR Table 462. OHR Table 462 can incorporate virtual network indicating information that indicates the shared virtual network of Tx VM 230 and the Rx VM. Such virtual network indicating information can include an identifier that directly identifies a particular virtual network or an identifier that indirectly indicates a particular virtual network (e.g., a VM identifier, a WQ identifier, a flow identifier, etc.). The virtual location of the Rx VM resides at a physical space location (e.g., a physical host) that is accessible by a physical access point (e.g., a CNA). OHR Table 462 can incorporate the physical network address of the physical access point (e.g., an Ethernet address of a CNA). Based on the virtual network indicating information, OHR Table 462 can indicate the memory location in OHR 460 of the associated encapsulation header (EH) 236. Based on the physical network address of the physical access point, OHR Table 462 can indicate the memory location in OHR 460 of the associated outer protocol header(s) (OPH) 238. OHR Table 462 can indicate the memory location(s) of a set of EH 236 and OPH 238 for every associated transmission frame.

Based on a table entry 466 of OHR Table 462, CNA 408 can further obtain the proper set of EH 436 and OPH 438 associated with the obtained frame components of WQE 422 (i.e., frame payload 432 and IH 434) by, e.g., one or more DMA engines 440 DMA-fetching or reading EH 436 and OPH 438 from OHR 460. With the obtained frame components of frame payload 432, CNA 408 has all the basic components for forming Ethernet frame 412.

Inner header(s) 234 and outer protocol header(s) 238 may be headers of Layer 2 (e.g., Ethernet), Layer 3 (e.g., IPv4, IPv6, IPX, etc.), Layer 4 (e.g., TCP, UDP, etc.) and other such protocols as understood by the standard Open Systems Interconnection model (OSI) or similar models.

The fully-aware example can include OHR cache 468. OHR cache 468 in on-chip memory of CNA 408 can cache sets of headers (e.g., a set of EH 436 and OPH 438) from OHR 460. A cached set of headers can correspond to a WQ (e.g., WQ 418) (or corresponding tenant VM, such as Tx VM 430) that is being (or has been in the recent past) actively serviced by CNA 408. The cached set of headers can be fetched and updated. The state of the cached set of headers can be tracked. In some instances, tracking may involve the use of various standard and proprietary methodologies (e.g., networking protocols such as ARP, DNS or vendor-specific protocols and mechanisms) in CNA 408 to obtain the state information. The specific cache-entry replacement algorithm may be one of any number of well-known strategies such as Least Recently Used (LRU) or First-In-First-Out (FIFO) or similar. OHR cache 468 may be populated on-demand with the OHR entries (i.e., sets of EH 436 and OPH 438) as they are fetched or read by DMA engines 440. In the alternate realization where the OHR area 460 has been offloaded to CNA 408, OHR cache 468 can contain the OHR area 460 that is populated by CNA 408, as mentioned earlier above.

WQE 422 can also indicate request(s) and instructions for offload and other processing. Enhanced WQE parsers 426 can support the use of an optional extended WQE format that presents offload and processing instructions for multiple headers (i.e., IH, 434, EH 436, and OPH 438). Such offload and other processing may be performed by enhanced offload engines 428. Prior to transmission of the final Ethernet frame 212, enhanced offload engines 428 may perform any requested offload and other processing operations to update and/or transform obtained frame components (e.g., frame payload 432, IH 434, EH 436, OPH 438). Enhanced offload engines 428 may perform these processing operations on the frame components separately and then assemble the processed components into a final Ethernet frame 412. Enhanced offload engines 428 may assemble the obtained frame components into a preliminary frame and then perform these processing operations on the assembled preliminary frame to produce a final Ethernet frame 412.

Examples of the processing operations performed by enhanced offload engines 428 can be varied. These operations could include updates to the L2, L3, L4 destination address elements (e.g., IPv4 address, TCP Port numbers, Ethernet addresses, etc.) in the headers of IH 434 or OPH 438. These operations also could include Layer 3 and Layer 4 Checksum computations, Large Segmentation Offloads, VLAN-Tag insertions, ACL checks, and similar offload processing operations. These operations may be requested and performed on the contents of one or more of IH 434, EH 436, and OPH 438. Additionally, these operations may alter frame payload 432, e.g., by the insertion of padding-bytes. The forwarding process decides the final destination of Ethernet frame 412 as well any differentiated servicing required on Ethernet frame 412. The final destination of Ethernet frame 412 may be the physical Ethernet port or Ethernet frame 412 may be looped back to the host-memory or Ethernet frame 412 may be “dropped” (based on various criteria such as frame header contents and rules in the CNA, etc.) among other options. The differentiated servicing may delay or expedite the forwarding of Ethernet frame 412, e.g., with respect to other in-flight Ethernet frames in the CNA (based on various criteria such a priority, bandwidth constraints, etc.).

Another example of processing performed by enhanced offload engines 428 can include the enhancements needed for the forwarding function in order to be able to use IH 434 and OPH 438 in forwarding decisions or for performing egress processing on the frame in an IOV environment. These are examples of the enhancements needed to support the encapsulation task offload and is not an exhaustive list.

CNA 408 may transmit Ethernet frame 412 onto a network connection 106 in FIG. 1. The physical network resources of network 100 may direct Ethernet frame 412 through network 100 based on OPH 438, which may indicate the physical network address of the physical access point to the Rx VM. For example, OPH 438 may indicate the Ethernet address of a CNA servicing the physical host where the Rx VM resides. Eventually, frame payload 432 (including the data intended for transmission from Tx VM 430 to the Rx VM) may be directed to the Rx VM according to various reception techniques, such as provided in, but not limited to, this disclosure.

In an alternative case, both Tx VM 430 and Rx VM may reside in the same physical host. Thus, CNA 408 may route Ethernet frame 412, not onto network connection 106, but within the same physical host. For example, OPH 438 may indicate the Ethernet address of the same CNA 408. Eventually, frame payload 432 (including the data intended for transmission from Tx VM 230 to the Rx VM) may be directed to the Rx VM according to various reception techniques, such as provided in, but not limited to, this disclosure.

The host-memory 514 (labeled as “HOST RAM”) depicted in FIG. 5 can be a sink for Ethernet frames to be received by CNA 508. Host-memory 514 can represent a pool of memory provided by one or more physical memory devices. Host-memory 514 can be apportioned into distinct memory areas (e.g., 516a, 516b, 516c), each memory area associated with a tenant VM or a hypervisor 520 in a host server-system. Hypervisor 520 can create and manage reception VM (Rx VM) 530. A single physical CNA 508 could be shared across multiple VMs managed by a single hypervisor 520 (e.g., in the case of an SR-IOV system) or be shared across multiple such server-systems via a shared fabric or bus 524 (e.g., in the case of an MR-IOV system).

Host-memory 514 can contain a Receive Queue (RQ) 542 belonging to hypervisor 520 or Rx VM 530. RQ 542 can contain one or more Receive Queue Entries (RQEs) that specify the address of buffers where contents of received frames are be deposited. The owner of RQ 542 (e.g., hypervisor 520 or Rx VM 530) can populate RQ 542 by writing RQEs to RQ 542.

Note that this is an example of a realization and other variants are possible, as well. For example, RQ 542 may be resident in on-board memory in CNA 508, and the owner of RQ 542 can write RQEs across a bus 524 (e.g., a PCIe Fabric as a shared bus) to pre-designated CNA memory location(s) representing RQ 542.

Differences between the partially-aware example of FIG. 3 and the fully-aware example of FIG. 5 exist, e.g., with regard to the respective ways that the multiple headers (i.e., inner header(s) (IH) 534, encapsulation header (EH) 536, and outer protocol header(s) (OPH) 538) of Ethernet frame 512 can be handled. In the fully-aware example, CNA 508 is not only aware of the existence of multiple headers but can also perform functions based on the contents of multiple headers. For an exemplary function, based on the contents of IH 534, EH 536, and OPH 538, CNA 508 can direct frame payload 532 to Rx VM 530, without involvement by hypervisor 520, unlike the partially-aware example of FIG. 3.

CNA 508 can include one or more DMA engines 546, one or more RQE parsers 548, one or more decapsulation offload engines 550, one or more decapsulation frame parsers 552, and one or more decapsulation look-up tables 554. CNA 508 can serve as I/O interface 108 in between physical host(s) 110 and network connection 106 in FIG. 1. CNA 508 can receive Ethernet frame 512 from a network connection 106. Based on the received Ethernet frame 512, CNA 508 can deliver information to host-memory 514 of physical host(s) 110.

Exemplary reception processes follow. A user of a transmission VM (Tx VM) would like to transmit data to Rx VM 530. Both the Tx VM and Rx VM 530 may belong to the same shared virtual network and can communicate with each other by transmission frames. Ethernet frame 512 may be transmitted into network 100 in FIG. 1 according to various transmission techniques, such as provided in, but not limited to, this disclosure. In the case that both the Tx VM and Rx VM 530 reside in the same physical host, CNA 508 may route Ethernet frame 512 directly between Tx VM and Rx VM 530, not through network 100. Ethernet frame 512 in FIG. 5 may correspond to Ethernet frame 212 in FIG. 2 or Ethernet frame 412 in FIG. 4. CNA 508 can receive an Ethernet frame 512 from a network connection 106 in FIG. 1. When both the Tx VM and Rx VM 530 reside in the same physical host, CNA 508 can route Ethernet frame 512 within itself, instead of receiving Ethernet frame 512 from network connection 106. The received Ethernet frame may include the following components: frame payload 532, inner header(s) (IH) 534, encapsulation header (EH) 536, and outer protocol header(s) (OPH) 538.

Frame payload 532 can include the data from Tx VM intended for reception by Rx VM 530. IH 534 can have addressing information indicating the virtual location of Rx VM 530 on the shared virtual network. EH 536 can include virtual network indicating information that indicates the shared virtual network of Tx VM and Rx VM 530. The virtual location of Rx VM 530 resides at a physical space location (e.g., a physical host) that is accessible by a physical access point (e.g., CNA 508). OPH 538 can indicate the physical network address of the physical access point (e.g., an Ethernet address of CNA 508).

Inner header(s) 534 and outer protocol header(s) 538 may be headers of Layer 2 (e.g., Ethernet), Layer 3 (e.g., IPv4, IPv6, IPX, etc.), Layer 4 (e.g., TCP, UDP, etc.) and other such protocols as understood by the standard Open Systems Interconnection model (OSI) or similar models.

Decapsulation frame parser (DFP) 552 can parse Ethernet frame 512 to process the contents of Ethernet frame 512. Based on OPH 538, CNA 508 can determine whether Ethernet frame 512 is addressed to CNA 508. If so, CNA 508 can continue processing of Ethernet frame 512. If not, CNA 508 can discard Ethernet frame 512.

DFP 552 can determine that a received Ethernet frame belongs to a certain kind of Ethernet frame—i.e., an Ethernet frame directed to virtual machines connecting to virtual networks. For example, DFP 552 can make a determination that Ethernet frame 512 has multiple sets of headers. DFP 552 can detect the existence of encapsulated frames. In addition, DFP 552 can extract values of pre-specified fields in the collection of headers (i.e., IH 434, EH 436, and OPH 438) for forwarding purposes. Also, DFP 552 may transform these values prior to their use in forwarding actions.

Detecting the existence of an EH 536 can allow parsing IH 534 and OPH 538 of Ethernet frame 512 correctly. Administratively configured or negotiated or even common values for specific fields in EH 536, and OPH 538 can provide virtual network isolation and virtualization for tenant VM traffic in the fabric. Examples of these fields include network endpoint identifiers (e.g., VLANs, destination MAC address, destination IP address, TCP/UDP Port number, etc.) or traffic types (e.g., FCoE, RoCE, TCP, UDP, etc.) or opaque tenant identifiers in EH 536. DFP 552 can extract these values from IH 534, EH 536, and OPH 538 for looking up the tenant VM targeted by Ethernet frame 512.

Decapsulation lookup table (DLT) 554 may include information about a location(s) in host-memory 514 where CNA 508 can write contents of Ethernet frame 512. DLT 554 can support the use of values from the same or differing fields from the collection of Headers (i.e., IH 534, EH 536, and OPH 538) in Ethernet frame 512. DLT entry 556 may indicate RQ 542 on one of various bases. As an example, the same destination MAC address field from both OPH 538 and IH 534 could be used to look up the tenant VM 530 uniquely in DLT 554. As another example, the destination MAC address from the OPH 538, an opaque cookie from the EH 536, and the destination IPv4 address from the IH 534 may be used to lookup the tenant VM 530 uniquely. Other such permutations are possible and supported by DLT 554.

DLT 554 may be used to look up the specific tenant VM targeted by the Ethernet frame 512 by using the parsed values from DFP 552. These parsed values may be further transformed prior to their use in DLT 554. A non-exhaustive list of such transform examples include encoding (e.g., encoding VLAN-ID ranges to a denser or more compact namespace), replacement/substitution (e.g., substituting a tenant MAC address with a predefined value in all lookups), hashing (e.g., hashing 4-tuple values), comparison/boolean operations as encoding methods, etc. These transforms may be specified as rules for operating on encapsulated (or otherwise) frames as part of the lookup process. The results of the lookup can decide the final destination of contents of Ethernet frame 512 and also decide the decapsulation and egress operations to be performed on Ethernet frame 512. The final destination of contents of Ethernet frame 512 may be a data buffer 558, whose location can be indicated by RQE 544 of RQ 542. Alternately, Ethernet frame 512 may be “dropped” (based on various criteria such as frame header contents and rules in the CNA, etc.) among other options.

Directed to RQ 542 by DLT entry 556, CNA 508 can obtain RQE 544 from RQ 542, e.g., by one or more DMA engines 546 DMA-fetching or reading RQE 544 from host-memory 514. RQE parser 548 can parse RQE 544 to obtain the physical address of buffers, e.g., data buffer 558, in host-memory 514 where contents of Ethernet frame 514 may be written.

Prior to forwarding contents of received Ethernet frame 512 to data buffer 558 in host-memory 514, decapsulation offload engines (DOE) 550 may perform any requested offload and other processing operations to update and/or transform frame components of Ethernet frame 512 (e.g., frame payload 532, IH 534, EH 536, OPH 538). Examples of the processing operations performed by DOE 550 can be varied. These operations could include Layer 3 and Layer 4 Checksum computations, Large Segmentation Offloads, VLAN-Tag removals, ACL checks, and similar offload processing operations. These operations may be requested and performed on the contents of one or more of IH 534, EH 536, and OPH 538. As another example, such operations may include the removal of the OPH 538 and/or EH 536 prior to placement in host-memory buffer 558. Additionally, these operations may alter frame payload 532, e.g., by the removal of padding-bytes.

One or more DMA engines 546 may transfer all or some contents of Ethernet frame 512 to data buffer 558 (or to a data buffer in memory area 516a associated with hypervisor 520 or to a data buffer in memory area 516b associated with VM #0). The transferred contents may be updated and/or transformed (or not) by DOE 550. Hypervisor 520 does not need to further process the transferred contents to eventually direct frame payload 532 (including the data from Tx VM intended for reception by Rx VM 530) to Rx VM 530. Instead, CNA 508 can perform the DMA transfer to data buffer 558 without involvement by hypervisor 520. Since data buffer 558 can be included in distinct memory area 516c that is associated with Rx VM 530 in the host server-system, Rx VM 530 can simply access the transferred contents directly. Thus, based on the contents of IH 534, EH 536, and OPH 538, CNA 508 (not hypervisor 520) may direct frame payload 532 to Rx VM 530.

The fully-aware examples above can perform stateless and stateful processing. One example of stateless processing may be using parsed values of multiple headers to look up a tenant VM uniquely. An example of stateful processing may be keeping track of the state of cached headers, whether they are currently in use or whether they have been used recently. By keeping track of the state, other stateful features are possible, such as keeping track of the state of the associated traffic-flow (and its source and destination), the associated WQ, the associated VM, the associated hypervisor, etc.

During an initialization period, a hypervisor may be involved in the fully-aware examples above to perform some initial setup tasks. For example, the hypervisor can fill pre-designated “Outer Header Region” (OHR) area of host-memory with sets of outer protocol headers and encapsulation headers. In one exemplary case, the content of the OHR area may be static; thus, it is unnecessary for the hypervisor to provide any further I/O processing after the OHR area is filled by the hypervisor. In another exemplary case, (some or all) content of the OHR area may be updated during operation after the OHR area is filled by the hypervisor. When such an OHR area is (completely or partially) offloaded onto the CNA, the CNA (and not the hypervisor) may autonomously perform the content updating of the offloaded OHR area; thus, it is unnecessary for the hypervisor to provide any further I/O processing. Therefore, the network I/O interface of the fully-aware examples can then bypass the hypervisor as the network I/O interface performs I/O processing on traffic-flows. As JOY techniques can also bypass the hypervisor, the fully-aware examples can incorporate IOV techniques.

In the partially-aware and fully-aware examples above, associations between for the various headers were provided. Inner headers were associated with addressing information indicating the virtual location of a Rx VM on a shared virtual network. Encapsulation headers were associated with virtual network indicating information that indicates the shared virtual network of a Tx VM and a Rx VM. Outer protocol headers were associated with a physical network address of a physical access point (e.g., an Ethernet address of a CNA). These associations, however, are merely exemplary and non-limiting.

In the partially-aware and fully-aware examples above, hypervisors were described. It should be noted that these descriptions of hypervisors are merely exemplary and non-limiting. For instance, the descriptions of hypervisor structure and functionalities are provided to facilitate understanding of the partially-aware and fully-aware examples. The scope of the partially-aware and fully-aware examples of this disclosure is not limited to those that interact with hypervisors in the exact manner described above. Instead, the scope encompasses partially-aware and fully-aware examples that interact with other hypervisor variants.

FIG. 6 illustrates an exemplary networking system 600 that can be used with one or more examples of this disclosure. Networking system 600 may include host 670, device 680, and network 690. Host 670 may include a computer, a server, a mobile device, or any other devices having host functionality. Device 680 may include a network interface controller (NIC) (similarly termed as network interface card or network adapter), such as an Ethernet card, a host bus adapter (as for Fibre Channel), a converged network adapter (CNA) (as for supporting both Ethernet and Fibre Channel), or any other device having network I/O interface functionality. Network 690 may include a router, a switch, transmission medium, and other devices having some network functionality.

Host 670 may include one or more host logic 672, a host memory 674, an interface 678, interconnected by one or more host buses 676. The functions of the host in the examples of this disclosure may be implemented by host logic 672, which can represent any set of processors or circuitry performing the functions. Host 670 may be caused to perform the functions of the host in the examples of this disclosure when host logic 672 executes instructions stored in one or more machine-readable storage media, such as host memory 674. Host 670 may interface with device 680 via interface 678.

Device 680 may include one or more device logic 682, a device memory 684, interfaces 688 and 689, interconnected by one or more device buses 686. The functions of the network I/O interface in the examples of this disclosure may be implemented by device logic 682, which can represent any set of processors or circuitry performing the functions. Device 680 may be caused to perform the functions of the network I/O interface in the examples of this disclosure when device logic 682 executes instructions stored in one or more machine-readable storage media, such as device memory 684. Device 680 may interface with host 670 via interface 688 and with network 690 via interface 689. Device 680 may be a CPU, a system-on-chip (SoC), a NIC inside a CPU, a processor with network connectivity, an HBA, a CNA, or a storage device (e.g., a disk) with network connectivity.

Conventional network I/O interfaces, such as conventional CNAs, are unaware of the encapsulation/decapsulation involved in network virtualization. Conventional CNAs are designed and capable of handling only a single set of protocol headers (e.g., headers of Layer 2, Layer 3, Layer 4, etc., according to the standard OSI model) in an Ethernet frame. In other words, such CNAs are unable to correctly process an Ethernet frame having the encapsulation involved in network virtualization. A conventional CNA can be deficient in multiple ways. For example, the conventional CNA lacks the physical resources to perform the encapsulation/decapsulation processing. As another example, the conventional CNA lacks the intelligence (e.g., properly configured circuitry and programming) to understand multiple headers.

Historically, network adapters have been designed to operate on the basis of only a single header. This conventional design practice is not trivial. Due to this fundamental design principle of single-header operation, components inside a CNA—DMA engines, WQE parsers, transmit offload engines, frame parsers, lookup tables, receive offload engines—are intentionally limited in resources (e.g., computational power, memory size, power consumption) or intelligence (e.g., programming instructions, software constructs) in order to engineer an optimized design for single-header operation. Thus, on the transmit side, a conventional CNA is significantly limited in any capability to provide an Ethernet frame with encapsulation for network virtualization (e.g., having multiple headers). On the receive side, the conventional CNA would not know how understand the extra information of the multiple headers, thus potentially leading to errors and inoperability.

This fundamental design principle of single-header operation is accompanied by significant bathers to modifying a conventional network adapter design to handle multiple headers. There is a barrier of the cost of extra resources (e.g., computational power, memory size, power consumption). There is a barrier of the technical difficulty of developing the extra intelligence (e.g., programming instructions, software constructs). There is the further technical difficulty of coordinating the myriad of engineering variables in hardware and software development to meet the demanding constraints in the field. For example, conventional network adapters are designed to operate in a power-constrained environment, which accordingly directs the field to pursue power-efficient designs for network adapters. Also, for a reference of time and effort, development may take one to two years. As the conventional design paradigm is single-header operation, the above considerations present barriers against leaving this conventional single-header design paradigm.

Furthermore, since the field understands that implementing network virtualization involves additional resources and intelligence, the field has focused on the parts of the network—the physical host and the physical network—that have relatively large margins in resources and intelligence, which permit flexibility in attempting potential solutions for network virtualization. In contrast, the physical I/O interface has relatively small margins for experimental efforts in developing network virtualization techniques. Therefore, generally, the physical I/O interface may not be considered to be a preferential location for developing network virtualization techniques.

Various advantages and benefits may be realized with the examples of this disclosure. Processes related to Ethernet frame encapsulation and decapsulation for providing network virtualization can be performed by the network I/O interfaces (e.g., a CNA) of this disclosure, instead of other parts of the network. The partially-aware examples can perform some of the processes. The fully-aware examples can perform more of the processes. The processing performed by these disclosed examples can relieve a hypervisor on a host-side CPU in server-systems from performing all the processes for network virtualization. Thus, server-side performance may become more efficient.

The fully-aware examples allow the co-deployment of network virtualization with other virtualization techniques at the physical I/O interface. IOV techniques can provide the benefit of efficient I/O processing. Virtual network overlays can provide the benefit of multi-tenancy solutions. The fully-aware examples can permit the combination of both kinds of benefits since IOV techniques can be combined with virtual network overlays (via frame encapsulation/decapsulation).

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

1. A network virtualization transmit device comprising:
logic comprising:
a work queue entry parser configured to parse a work queue entry from a host-memory work queue;
a data payload reader configured to read a data payload from a host-memory data payload location based on the parsed work queue entry;
a first header reader configured to read a first header from a host-memory first header location based on the parsed work queue entry;
an additional header reader configured to read one or more additional headers from one or more additional header locations; and
a frame assembler configured to assemble a data frame based on the data payload, the first header, and the one or more additional headers.

2. The network virtualization transmit device of claim 1, wherein the first header is an inner header, and the one or more additional headers comprises an encapsulation header or an outer protocol header.

3. The network virtualization transmit device of claim 1, wherein the additional header reader is configured to read the one or more additional headers from the one or more additional header locations based on the parsed work entry.

4. The network virtualization transmit device of claim 1, the logic further comprising:
an additional header location indicator configured to indicate the one or more additional header locations based on an association between the one or more additional headers and at least one of the work queue entry, the host-memory work queue, and a traffic-flow,
wherein the additional header reader is configured to read the one or more additional headers from the one or more additional header locations indicated by the additional header location indicator.

5. The network virtualization transmit device of claim 4, the logic further comprising:
an additional header storage area configured to store the one or more additional headers; and
an additional header state tracker configured to track the state of the stored one or more additional headers.

6. The network virtualization transmit device of claim 2, the logic further comprising:
an offload engine configured to process the inner header or the encapsulation header, and
wherein the frame assembler is configured to assemble the data frame based on the processed header.

7. A network adapter incorporating the network virtualization transmit device of claim 1.

8. A server incorporating the network adapter of claim 7.

9. A network incorporating the server of claim 8.

10. A network virtualization receive device comprising:
logic comprising:
a frame parser configured to parse a data frame having a data payload, a first header, and one or more additional headers;
a receiver queue indicator configured to indicate a receive queue in a host-memory;
a receive queue entry parser configured to parse a receive queue entry from the receive queue to indicate a data buffer in the host-memory; and
a data writer configured to write the data payload and the first header to the data buffer in the host-memory.

11. The network virtualization receive device of claim 10, wherein the first header is an inner header, and the one or more additional headers comprises an encapsulation header or an outer protocol header.

12. The network virtualization receive device of claim 11, wherein the data writer is configured to write the encapsulation header or the outer protocol header to the data buffer in the host-memory.

13. The network virtualization receive device of claim 10,
wherein the frame parser is configured to determine values from two or more of the first header and the one or more additional headers,
wherein the receive queue indicator is configured to indicate the receive queue based on the determined values.

14. The network virtualization receive device of claim 11, the logic further comprising:
an offload engine configured to process the inner header or the encapsulation header, and
wherein the data writer is configured to write the processed header to the data buffer in the host-memory.

15. A network adapter incorporating the network virtualization receive device of claim 10.

16. A server incorporating the network adapter of claim 15.

17. A network incorporating the server of claim 16.

18. A method for network virtualization at a transmit side comprising:
parsing a work queue entry from a host-memory work queue;
reading a data payload from a host-memory data payload location based on the parsed work queue entry;
reading a first header from a host-memory first header location based on the parsed work queue entry;
reading one or more additional headers from one or more additional header locations; and
assembling a data frame based on the data payload, the first header, and the one or more additional headers.

19. The method of claim 18, wherein the first header is an inner header, and the one or more additional headers comprises an encapsulation header or an outer protocol header.

20. The method of claim 18, wherein the reading one or more additional headers includes reading the one or more additional headers from the one or more additional header locations based on the parsed work entry.

21. The method of claim 18, further comprising:
indicating the one or more additional header locations based on an association between the one or more additional headers and at least one of the work queue entry, the host-memory work queue, and a traffic-flow,
wherein the reading one or more additional headers includes reading the one or more additional headers from the one or more additional header locations indicated by the indicating the one or more additional header locations.

22. The method of claim 21, further comprising:
storing the one or more additional headers; and
tracking the state of the stored one or more additional headers.

23. The method of claim 19, further comprising:
processing the inner header or the encapsulation header, and
wherein the assembling the data frame includes assembling the data frame based on the processed header.

24. A method for network virtualization at a receive side comprising:
parsing a data frame having a data payload, a first header, and one or more additional headers;
indicating a receive queue in a host-memory;
parsing a receive queue entry from the receive queue to indicate a data buffer in the host-memory; and
writing the data payload and the first header to the data buffer in the host-memory.

25. The method of claim 24, wherein the first header is an inner header, and the one or more additional headers comprises an encapsulation header or an outer protocol header.

26. The method of claim 25, wherein the writing includes writing the encapsulation header or the outer protocol header to the data buffer in the host-memory.

27. The method of claim 24,
wherein the parsing a data frame includes determining values from two or more of the first header and the one or more additional headers,
wherein the indicating the receive queue in the host-memory includes indicating the receive queue based on the determined values.

28. The method of claim 25, further comprising:
processing the inner header or the encapsulation header, and
wherein the writing includes writing the processed header to the data buffer in the host-memory.

29. A machine-readable medium for a network virtualization transmit device, the medium storing instructions that, when executed by one or more processors, cause the transmit device to perform a method comprising:
parsing a work queue entry from a host-memory work queue;
reading a data payload from a host-memory data payload location based on the parsed work queue entry;
reading a first header from a host-memory first header location based on the parsed work queue entry;
reading one or more additional headers from one or more additional header locations; and
assembling a data frame based on the data payload, the first header, and the one or more additional headers.

30. The machine-readable medium of claim 29, wherein the first header is an inner header, and the one or more additional headers comprises an encapsulation header or an outer protocol header.

31. The machine-readable medium of claim 29, wherein the reading one or more additional headers includes reading the one or more additional headers from the one or more additional header locations based on the parsed work entry.

32. The machine-readable medium of claim 29, the method further comprising:
indicating the one or more additional header locations based on an association between the one or more additional headers and at least one of the work queue entry, the host-memory work queue, and a traffic-flow,
wherein the reading one or more additional headers includes reading the one or more additional headers from the one or more additional header locations indicated by the indicating the one or more additional header locations.

33. The machine-readable medium of claim 32, the method further comprising:
storing the one or more additional headers; and
tracking the state of the stored one or more additional headers.

34. The machine-readable medium of claim 30, the method further comprising:
processing the inner header or the encapsulation header, and
wherein the assembling the data frame includes assembling the data frame based on the processed header.

35. A machine-readable medium for a network virtualization receive device, the medium storing instructions that, when executed by one or more processors, cause the receive device to perform a method comprising:
parsing a data frame having a data payload, a first header, and one or more additional headers;
indicating a receive queue in a host-memory;
parsing a received queue entry from the receive queue to indicate a data buffer in the host-memory; and
writing the data payload and the first header to the data buffer in the host-memory.

36. The machine-readable medium of claim 35, wherein the first header is an inner header, and the one or more additional headers comprises an encapsulation header or an outer protocol header.

37. The machine-readable medium of claim 36, wherein the writing includes writing the encapsulation header or the outer protocol header to the data buffer in the host-memory.

38. The machine-readable medium of claim 35,
wherein the parsing a data frame includes determining values from two or more of the first header and the one or more additional headers,
wherein the indicating the receive queue in the host-memory includes indicating the receive queue based on the determined values.

39. The machine-readable medium of claim 36, the method further comprising:
processing the inner header or the encapsulation header, and
wherein the writing includes writing the processed header to the data buffer in the host-memory.
